(19) United States
(12) Patent Application Publication
(10) Pub. No.: US 2019/0208030 A1
(43) Pub. Date: Jul. 4, 2019

(54) PROXY DEVICE AND PROVIDER DEVICE

(71) Applicant: FUJITSU CLIENT COMPUTING LIMITED, Kanagawa (JP)

(72) Inventors: Kazutoshi Taniyama, Kawasaki (JP); Masatoshi Kimura, Kawasaki (JP)

(73) Assignee: FUJITSU CLIENT COMPUTING LIMITED, Kanagawa (JP)

(21) Appl. No.: 16/295,989

(22) Filed: Mar. 7, 2019

Related U.S. Application Data
(63) Continuation of application No. PCT/JP2018/021356, filed on Jun. 4, 2018.

(30) Foreign Application Priority Data
Jun. 15, 2017 (JP) 2017-117373

(51) Int. Cl. H04L 29/08; G06F 16/901; G09B 5/08

(52) U.S. Cl. CPC H04L 67/288; G09B 5/08; G06F 16/9017; H04L 67/1097

(57) ABSTRACT

A proxy device includes a request receiver that receives a request for acquisition of data from a requesting device; an acquirer that acquires the requested data from a server; storage that stores therein the data acquired from the server; and a controller that controls, upon no storage of the requested data in the storage, the acquirer to acquire, from the server, the requested data and other data stored in a same location of the storage.

### CROSS-REFERENCE TO RELATED APPLICATIONS

This application is a continuation of the PCT International Application No. PCT/JP2018/021356, filed on Jun. 4, 2018, which designates the United States, the entire contents of which are incorporated herein by reference.

### FIELD

Embodiments described herein generally relate to a proxy device and a provider device.

### BACKGROUND

Proxy servers are installed on communication paths between terminal devices and data servers that store and transmit data in response to requests from the terminal devices (disclosed in Japanese Laid-open Patent Publication No. 11-15718 and No. 2001-51983, for example).

### SUMMARY

Such a proxy server stores copies of data in the data server and transmits data in response to a request from a terminal device in place of the data server. Use of the proxy server can shorten the time taken for the terminal device to acquire data.

For example, the proxy server stores in advance copies of data to be acquired by the terminal device from the data server. Owing to the copies of data pre-stored in the proxy server, the terminal device can acquire data from the proxy server instead of the data server. By receiving designation of data to copy, the proxy server can acquire copies of the data in advance. However, designating data to be stored in the proxy server may be a burden on the user of the proxy server.

An object of one aspect of this disclosure is to provide a proxy device and a provider device that enable omission of the designation of data to be stored in the proxy device that transmits data to a requesting device in place of a server.

One aspect of this disclosure is exemplified by the following device. A proxy device includes a request receiver, an acquirer, storage and a controller. The request receiver receives a request for acquisition of data from a requesting device. The acquirer acquires the requested data from a server. The storage stores therein the data acquired from the server. The controller controls, upon no storage of the requested data in the storage, the acquirer to acquire, from the server, the requested data and other data stored in the same location of the storage.

### BRIEF DESCRIPTION OF DRAWINGS

FIG. 1 is a diagram illustrating an example of a lesson support system according to a first embodiment;

FIG. 2 is a diagram illustrating an example of IP address assignment in the first embodiment;

FIG. 3 is a diagram illustrating an example of a hardware configuration of a proxy server according to the first embodiment;

FIG. 4 is a diagram illustrating an example of a hardware configuration of a class server according to the first embodiment;

FIG. 5 is a diagram illustrating an example of a directory configuration of the class server for storing electronic teaching materials according to the first embodiment;

FIG. 6 is a diagram illustrating an example of an operation screen of a lesson support application that works on a terminal according to the first embodiment;

FIG. 7A is a diagram illustrating an example of processing blocks of the proxy server according to the first embodiment;

FIG. 7B is a diagram illustrating an example of a management table according to the first embodiment;

FIG. 8 is a flowchart illustrating an example of processing performed by the proxy server according to the first embodiment;

FIG. 9 is a sequence diagram illustrating an example of processing sequence performed by the lesson support system according to the first embodiment; FIG. 10 is a diagram illustrating an example of processing sequence performed by the lesson support system according to the first embodiment;

FIG. 11 is a diagram illustrating an example of processing sequence according to a first example for comparison;

FIG. 12 is a diagram illustrating an example of processing sequence according to a second example for comparison;

FIG. 13 is a diagram illustrating an example of a directory configuration of a class server for storing electronic teaching materials according to a first modification;

FIG. 14 is a diagram illustrating an example of processing blocks of a class server according to a second embodiment;

FIG. 15 is a flowchart illustrating an example of processing performed by the class server according to the second embodiment;

FIG. 16 is a sequence diagram illustrating an example of processing sequence performed by a lesson support system according to the second embodiment; and

FIG. 17 is a diagram illustrating an example of processing sequence performed by the lesson support system according to the second embodiment.

### DETAILED DESCRIPTION

Embodiments will be described below with reference to the accompanying drawings. Configurations of the embodiments are merely exemplary, and are not intended to limit the scope of this disclosure.

### First Embodiment

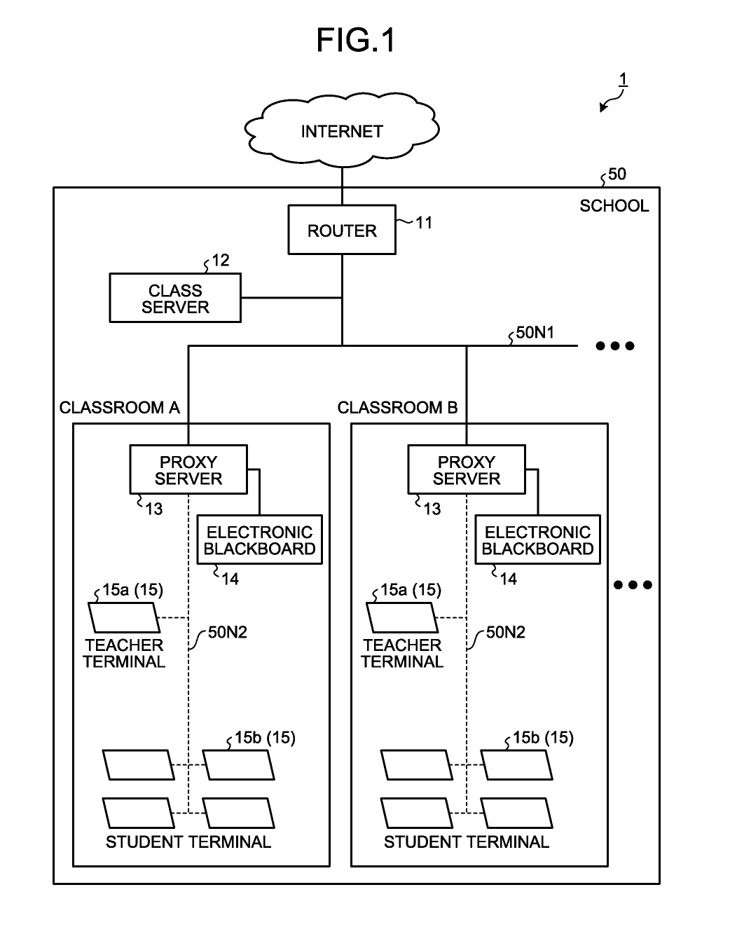

A first embodiment will describe a lesson support system that supports lessons using a computer, by way of example. FIG. 1 is a diagram illustrating an example of a lesson support system 1 according to the first embodiment. The lesson support system 1 is installed in a school 50. The school 50 has a plurality of classrooms (a classroom A, a classroom B, . . . ), and provides lessons in each of the classrooms using a computer. The lesson support system 1 includes a router 11, a class server 12, proxy servers 13, electronic blackboards 14, teacher terminals 15a, and student terminals 15b. The proxy server 13, the electronic blackboard 14, the teacher terminal 15a, and the student terminals 15b are installed in each of the classrooms. The router 11, the class server 12, and the proxy servers 13 are connected to one another via, for example, an intra-school network 50N1. The proxy server 13, the teacher terminal 15a, and the student terminals 15b are connected to one another via, for example, an intra-classroom network 50N2. All the systems in the classrooms have the same configuration; therefore, the classroom A will be described as a representative.

The router 11 represents an information processing device that connects the intra-school network 50N1 and the Internet. The router 11 may be referred to as a gateway device of the school 50. The intra-school network 50N1 and the intra-classroom networks 50N2 are networks that communicably connect information processing devices to one another. The intra-school network 50N1 is, for example, a wired local area network (LAN). The intra-classroom networks 50N2 are, for example, wireless LANs. A transmission rate of the intra-school network 50N1 is, for example, 10 megabits per second (Mbps) or 100 Mbps. However, the transmission rates of the intra-school network 50N1 and the intra-classroom networks 50N2 are not specifically limited. The intra-school network 50N1 may be a wireless LAN, and the intra-classroom networks 50N2 may be wired LANs.

The class server 12 represents an information processing device that stores electronic teaching materials for use in lessons. The class server 12 makes the stored electronic teaching materials available to the school 50. The electronic teaching materials are, for example, files including slides, moving images, and text. The electronic teaching materials may be interactive applications that run in accordance with teachers' or students' operation. The class server 12 makes the electronic teaching materials available by, for example, hypertext transfer protocol (HTTP). The class server 12 is connected to the intra-school network 50N1. The class server 12 is one example of a server and a provider device. The electronic teaching materials are one example of data.

The teacher terminal 15a is an information processing device for use by teachers, and the student terminals 15b are information processing devices for use by students. The teacher terminal 15a and the student terminals 15b are collectively referred to as terminals 15. The terminals 15 are, for example, tablet personal computers. The terminals 15 include, for example, touch panels. A lesson support application, for allowing acquisition of the electronic teaching materials from the class server 12, runs on the terminals 15. The teachers and students can acquire the electronic teaching materials through, for example, operating the lesson support application by touch on the touch panels of the terminals 15. The terminals 15 are connected to the intra-classroom network 50N2. The terminals 15 are one example of a requesting device.

The proxy server 13 represent an information processing device provided on the communication paths between the class server 12 and the terminals 15. The proxy server 13 is installed in each of the classrooms including the classroom A. The proxy server 13 is installed in a location such that the proxy server 13 can communicate with the terminals 15 at a higher speed than the class server 12. In other words, a network distance between the proxy server 13 and the terminals 15 is shorter than a network distance between the class server 12 and the terminals 15. The proxy server 13 stores therein copies of the electronic teaching materials stored in the class server 12. Upon detecting an acquisition request for an electronic teaching material from one of the terminals 15, the proxy server 13 determines whether the requested electronic teaching material is stored in the storage of the proxy server 13. With the requested electronic teaching material found in the storage, the proxy server 13 reads the material from the storage and transmits the material to the terminal 15 that has issued the request. With no requested electronic teaching material found in the storage, the proxy server 13 acquires the material from the class server 12 and transmits the material to the terminal 15. In other words, the proxy server 13 functions as a proxy server installed on the intra-classroom network 50N2. The proxy server 13 also functions as a wireless LAN access point to provide the intra-classroom network 50N2, which is a communication environment via a wireless LAN, to the classroom A. The proxy server 13 is one example of a proxy device.

The electronic blackboard 14 is a display that is connected to the proxy server 13. The electronic blackboard 14 represents, for example, a cathode ray tube (CRT) display, a liquid crystal display (LCD), a plasma display panel (PDP), an electroluminescence (EL) panel, or an organic EL panel. For example, the electronic blackboard 14 displays an electronic teaching material displayed on the terminal 15 via the proxy server 13. The electronic blackboard 14 is connected to the proxy server through, for example, a high-definition multimedia interface (HDMI (registered trademark)) cable.

IP Address Assignment

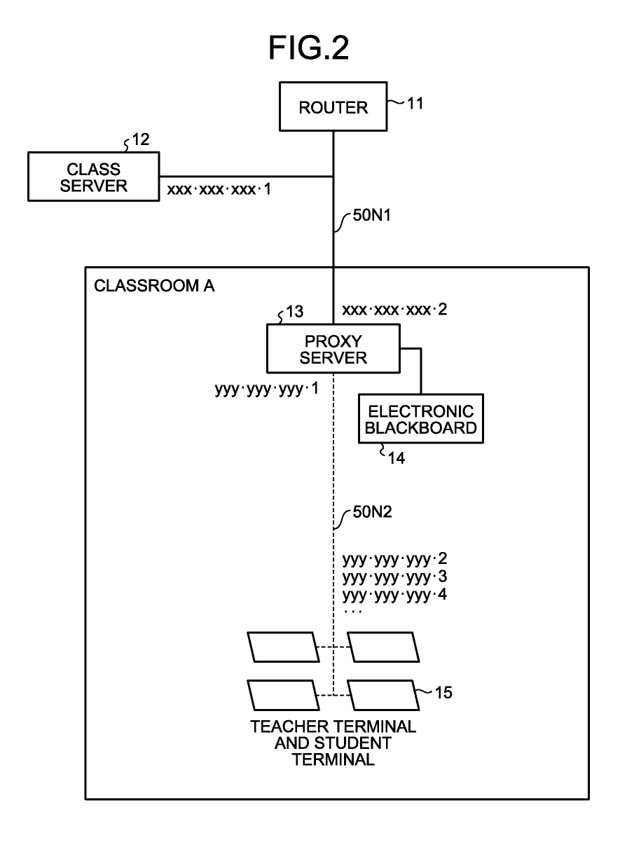

FIG. 2 is a diagram illustrating an example of IP address assignment in the lesson support system 1. For convenience of explanation, FIG. 2 shows part of the IP addresses with alphabets such as “x” and “y”. One example of the IP address assignment will be described below with reference to FIG. 2.

An IP address “xxx.xxx.xxx.1” is assigned to the class server 12. An IP address “xxx.xxx.xxx.2” is assigned to one side of the proxy server 13 connected to the intra-school network 50N1. For example, the class server 12 and the side of the proxy server 13 connected to the intra-school network 50N1 belong to the same subnet. An IP address “yyy.yyy.yyy.1” is assigned to the other side of the proxy server 13 connected to the intra-classroom network 50N2. IP addresses “yyy.yyy.yyy.2”, “yyy.yyy.yyy.3”, and “yyy.yyy.yyy.4” . . . are assigned to the terminals 15. For example, the terminals 15 and the side of the proxy server 13 connected to the intra-classroom network 50N2 belong to the same subnet. For communication between the intra-school network 50N1 and the intra-classroom network 50N2, the proxy server 13 translates the IP addresses by network address translation (NAT), for instance. In FIG. 2 the intra-school network 50N1 and the intra-classroom network 50N2 belong to different subnets, however, they may belong to the same subnet.

Hardware Configuration of Proxy Server 13

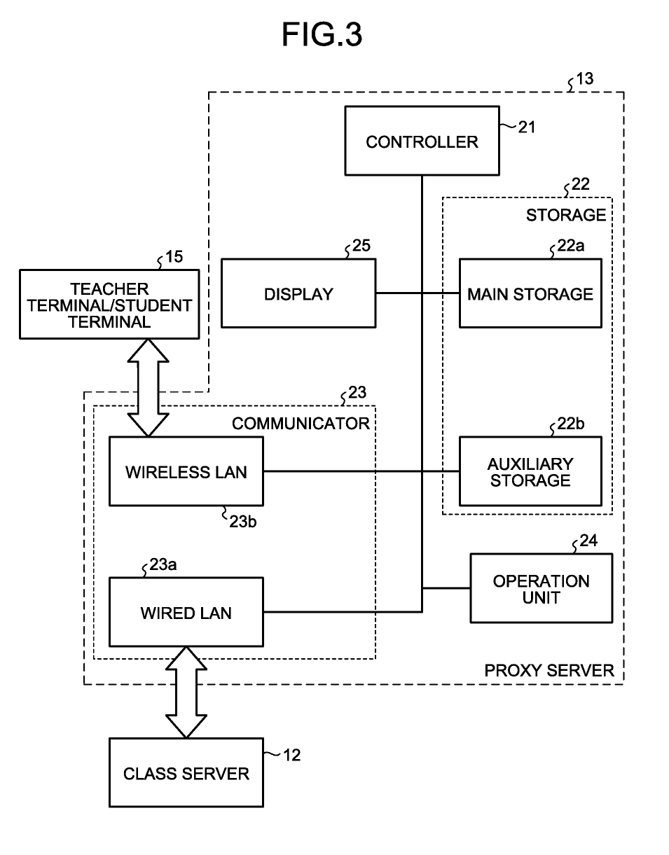

FIG. 3 is a diagram illustrating an example of a hardware configuration of the proxy server 13. The proxy server 13 includes a controller 21, a storage 22, a communicator 23, an operation unit 24, and a display 25. The controller 21, the storage 22, the communicator 23, the operation unit 24, and the display 25 are electrically connected to one another. The hardware configuration of the proxy server 13 will be described below with reference to FIG. 3.

The controller 21 is hardware that is also referred to as a central processing (CPU), a micro processing unit (MPU), or a processor. The class server 12 is not limited to a single processor, but may have a multi-processor configuration. A single controller 21 connected via a single socket may have a multi-core configuration. At least part of processing to be performed by the controller 21 may be performed by another processor, e.g., a dedicated processor such as a digital signal processor (DSP), a graphics processing unit (GPU), a numerical processor, a vector processor, or an image processor. At least part of the processing to be performed by the controller 21 may be performed by an integrated circuit (IC) or other digital circuits. At least part of the controller 21 may include an analog circuit. The integrated circuit includes a large scale integration (LSI), an application specific integrated circuit (ASIC), and a programmable logic device (PLD). The PLD includes, for example, a field-programmable gate array (FPGA). The controller 21 may be a combination of a processor and an integrated circuit. Such a combination is referred to as, for example, a micro-controller unit (MCU), a system-on-a-chip (SoC), a system LSI, or a chipset. In the class server 12, the controller 21 loads a program from an auxiliary storage 22b onto a work area of a main storage 22a, and controls peripheral devices by executing the program. Thereby, the class server 12 can perform operation for intended purposes. The main storage 22a and the auxiliary storage 22b are recording media that are readable by the proxy server 13.

The storage 22 includes the main storage 22a and the auxiliary storage 22b. The main storage 22a is an example of a storage that is directly accessed by the controller 21. The main storage 22a includes a random access memory (RAM) and a read only memory (ROM).

The auxiliary storage 22b stores various programs and various kinds of data in a recording medium in a readable and writable manner. The auxiliary storage 22b may be referred to as an external storage device. The auxiliary storage 22b stores an operating system (OS), various programs, and various tables. The OS includes a communication interface program for sending and receiving data to and from external devices that are connected via the communicator 23. The external devices include, for example, other information processing devices and other external storage devices that are connected via a computer network. The auxiliary storage 22b represents, for example, an erasable programmable ROM (EPROM), a solid state drive (SSD), or a hard disk drive (HDD). Further, the auxiliary storage 22b may be provided through, for example, a network attached storage (NAS) or a storage area network (SAN).

The communicator 23 represents, for example, an interface with a computer network. The communicator 23 includes a wired LAN 23a and a wireless LAN 23b. The wired LAN 23a is connected to the intra-school network 50N1. The wired LAN 23a communicates with other information processing devices via the intra-school network 50N1, for example. The wireless LAN 23b is operable as a wireless LAN access point. The wireless LAN 23b provides the intra-classroom network 50N2 in the classroom A. The wireless LAN 23b communicates with other information processing devices via the intra-classroom network 50N2.

The operation unit 24 receives operational instructions from teachers and students, for instance. The operation unit 24 represents, for example, a keyboard, a pointing device, a touch panel, an acceleration sensor, or a voice input device.

The display 25 is one example of an output that outputs results of the processing by the proxy server 13. The display 25 represents, for example, a cathode ray tube (CRT) display, a liquid crystal display (LCD), a plasma display panel (PDP), an electroluminescence (EL) panel, or an organic EL panel. The display 25 may be, for example, the electronic blackboard 14 as described above.

Hardware Configuration of Class Server 12

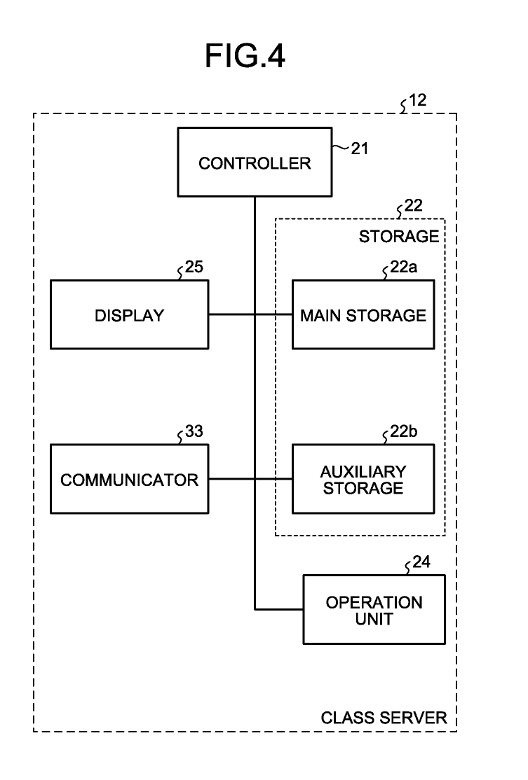

FIG. 4 is a diagram illustrating an example of a hardware configuration of the class server 12. The same components as those illustrated in FIG. 3 are denoted by the same reference signs, and explanation thereof will be omitted. The hardware configuration of the class server 12 will be described below with reference to FIG. 4.

A communicator 33 represents, for example, an interface with a computer network. The communicator 33 is connected to the intra-school network 50N1. The communicator 33 communicates with other information processing devices via the intra-school network 50N1.

Directory Configuration of Class Server 12

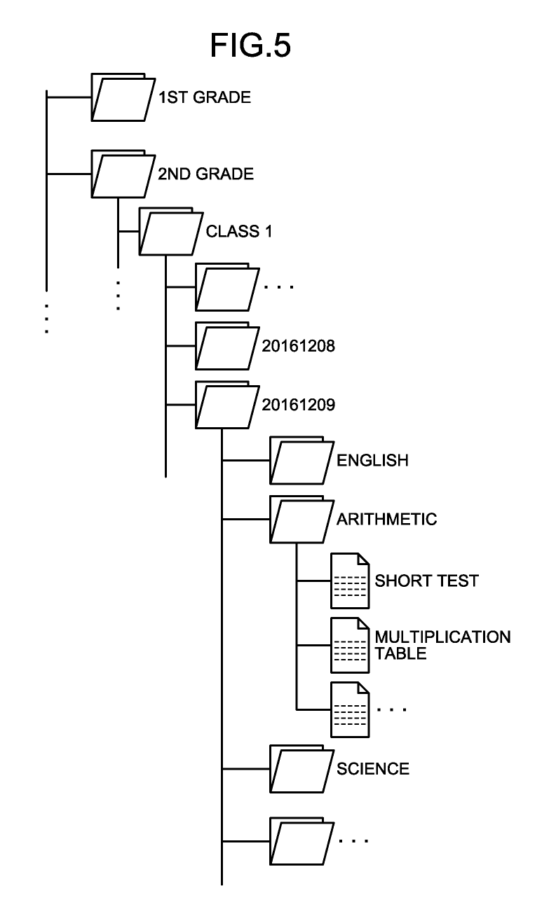

In the class server 12, electronic teaching materials are classified for use in each lesson and stored in directories. The directories are also referred to as folders. FIG. 5 is a diagram illustrating an example of a directory configuration of the class server 12 for storing electronic teaching materials. The directory configuration illustrated in FIG. 5 is generated on, for example, the auxiliary storage 22b of the class server 12. An example of the directory configuration of the class server 12 will be described below with reference to FIG. 5.

In the class server 12, electronic teaching materials are stored in hierarchical structure in the directories. In the directory hierarchical structure illustrated in FIG. 5, directories for respective grades are generated as higher-level directories. Class directories are generated in each of the grade directories. Date directories are generated in each of the class directories. In FIG. 5, date is represented by a 4-digit year, a 2-digit month, and a 2-digit day. Subject directories are generated in each of the date directories. Electronic teaching materials are stored in each of the subject directories. That is, in the directory configuration illustrated in FIG. 5, electronic teaching materials to be used in the same class are stored in the same directory. For example, an electronic teaching material with a file name, “multiplication table” illustrated in FIG. 5 is an exemplary electronic teaching material to be used in a lesson of a subject “arithmetic” in the 2nd grade, class 1 on Dec. 9, 2016. Hereinafter, the electronic teaching material with the file name “multiplication table” will be referred to as an electronic teaching material, multiplication table. FIG. 5 omits showing an extension of the file name. In the first embodiment the class server 12 is assumed to store electronic teaching materials in accordance with the above directory configuration shown in FIG. 5. The directory is one example of a storage location.

Operation Screen of Terminal 15

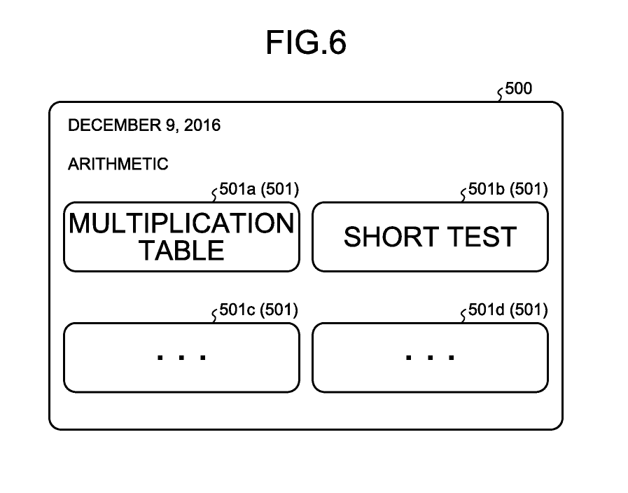

FIG. 6 is a diagram illustrating an example of an operation screen 500 of the lesson support application that runs on the terminal 15. For example, upon startup, the lesson support application, running on the terminal 15, accesses the class server 12 and reads a list of directories from the class server 12. The lesson support application displays the operation screen 500 as illustrated in FIG. 6, on the basis of the read list of directories. Operation buttons 501a, 501b, 501c, and 501d are displayed on the operation screen 500. The operation buttons 501a, 501b, 501c, and 501d may be collectively referred to as operation buttons 501. Names of electronic teaching materials are displayed on the operation buttons 501. Upon a touch of any of the operation buttons 501, the terminal 15 transmits, to the class server 12, an acquisition request for an electronic teaching material corresponding to the touched operation button 501. The acquisition request includes, for example, location information of the electronic teaching material. The location information represents, for example, a uniform resource locator (URL) of the electronic teaching material. The acquisition request is based on HTTP, for example. Upon a touch of the operation button 501a, for example, the terminal 15 transmits, to the class server 12, an acquisition request for the electronic teaching material, multiplication table to be used in the arithmetic lesson in the 2^{nd}-grade, class 1 on Dec. 9, 2016. The acquisition request for the electronic teaching material, multiplication table includes, for example, a URL, “http://xxx.xxx.xxx.1/2nd grade/class 1/20161209/arithmetic/multiplication table”, of the electronic teaching material, multiplication table.

Processing Blocks of Proxy Server 13

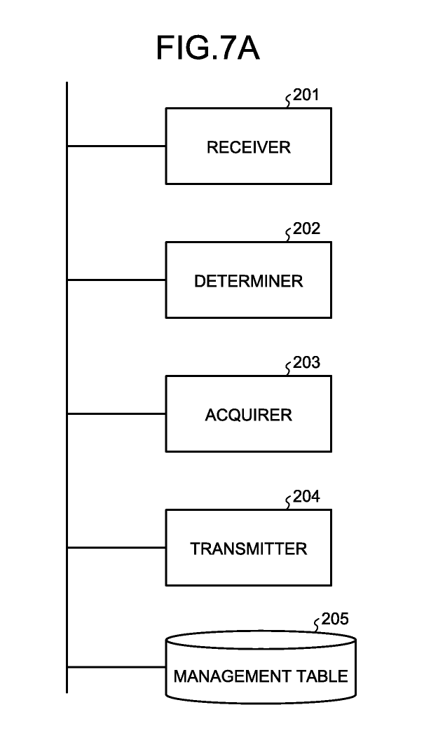

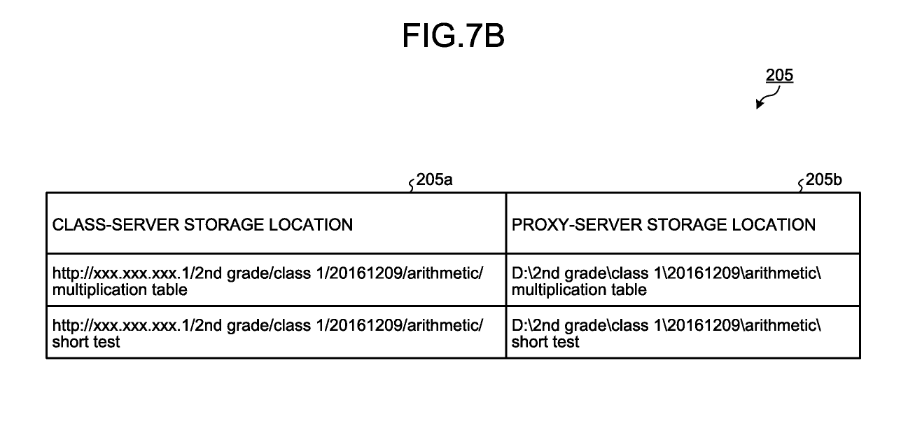

FIG. 7A is a diagram illustrating an example of processing blocks of the proxy server 13. The proxy server 13 includes a receiver 201, a determiner 202, an acquirer 203, a transmitter 204, and a management table 205. In the proxy server 13, the controller 21 executes a computer program loaded on the main storage 22a to implement the operations of the receiver 201, the determiner 202, the acquirer 203, and the transmitter 204. One example of the processing blocks of the proxy server 13 will be described below with reference to FIG. 7A.

The management table 205 is a table for managing locations of electronic teaching materials in the class server 12 and locations of the same electronic teaching materials in the auxiliary storage 22b of the proxy server 13 in association with each other. FIG. 7B is a diagram illustrating an example of the management table 205 according to the first embodiment. The management table 205 contains fields of a class-server storage location 205a and a proxy-server storage location 205b. For example, location information of an electronic teaching material, contained in the acquisition request for the electronic teaching material transmitted from the terminal 15 to the class server 12, is stored in the class-server storage location 205a. Location information of the electronic teaching material, which is stored by the acquirer 203 in the auxiliary storage 22b of the proxy server 13, is stored in the proxy-server storage location 205b. For example, the proxy-server storage location 205b stores a path name of the electronic teaching material stored in the auxiliary storage 22b of the proxy server 13. FIG. 7B shows, by way of example, that an electronic teaching material, which is acquired from “http://xxx.xxx.xxx.1/2nd grade/class 1/20161209/arithmetic/multiplication table” of the class server 12, is stored in the proxy server 13 at “D:\2nd grade\class 1\20161209\arithmetic\multiplication table”.

The receiver 201 receives the acquisition request for the electronic teaching material transmitted from the terminal 15 to the class server 12. The determiner 202 determines whether the requested electronic teaching material is stored in the auxiliary storage 22b of the proxy server 13. The determiner 202 makes the determination referring to the management table 205. The determiner 202 extracts, for example, location information of the electronic teaching material from the acquisition request received by the receiver 201. Upon determining that the extracted location information of the electronic teaching material is stored in the management table 205, the determiner 202 can determine that the electronic teaching material is stored in the auxiliary storage 22b of the proxy server 13. The determination may be based on, for example, whether an electronic teaching material having the same file name as the requested electronic teaching material is stored in the auxiliary storage 22b of the proxy server 13. The receiver 201 is one example of a request receiver.

With no requested electronic teaching material found in the auxiliary storage 22b of the proxy server 13, the acquirer 203 acquires the electronic teaching material concerned from the class server 12. The acquirer 203 further acquires, from the class server 12, an electronic teaching material that is stored in the same directory storing the requested electronic teaching material. The acquirer 203 stores the acquired electronic teaching materials in the auxiliary storage 22b of the proxy server 13. The acquirer 203 updates the management table 205 with the electronic teaching materials stored in the auxiliary storage 22b of the proxy server 13. Thus, the acquirer 203 stores, in the class-server storage location 205a, storage information indicating the locations of the acquired electronic teaching materials in the class server 12. The acquirer 203 stores, in the proxy-server storage location 205b, path names of the electronic teaching materials stored in the auxiliary storage 22b of the proxy server 13. The acquirer 203 that stores the electronic teaching materials in the auxiliary storage 22b of the proxy server 13 is one example of an acquirer.

In response to the acquisition request from the terminal 15, the transmitter 204 transmits the electronic teaching material to the terminal 15. The transmitter 204 extracts the location information of the electronic teaching material from the acquisition request received by the receiver 201. The transmitter 204 acquires information from the proxy-server storage location 205b in association with the extracted location information of the electronic teaching material, referring to the management table 205. The transmitter 204 reads the electronic teaching material from the location designated by the information stored in the proxy-server storage location 205b. The transmitter 204 transmits the read electronic teaching material to the terminal 15 that has issued the request.

Flow of Processing by Proxy Server 13

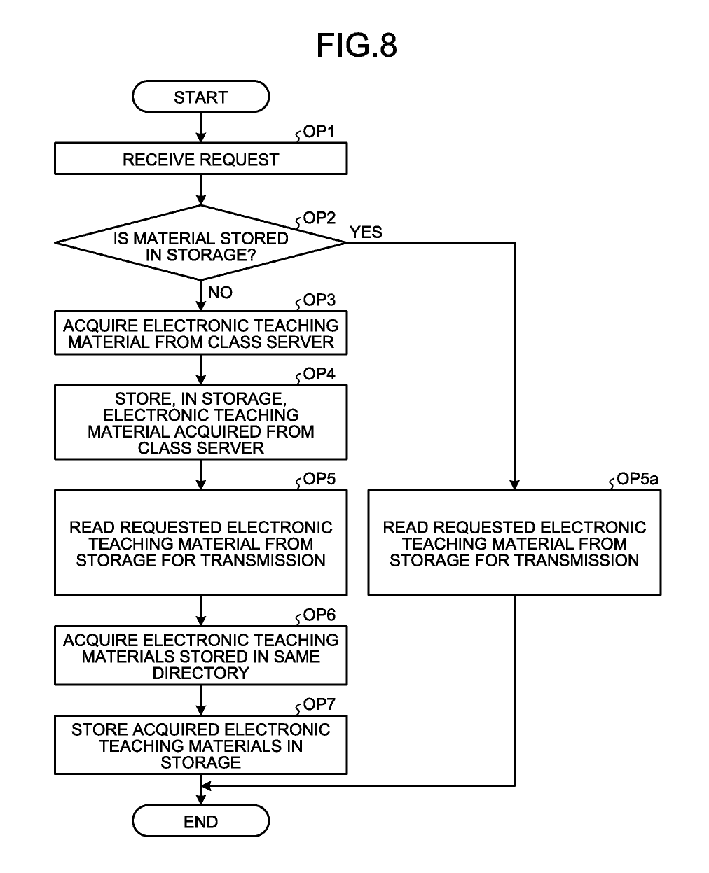

FIG. 8 is a flowchart illustrating exemplary processing by the proxy server 13 according to the first embodiment. One example of the flow of processing by the proxy server 13 according to the first embodiment will be described below with reference to FIG. 8.

At OP1, the receiver 201 receives, from the terminal 15, an acquisition request for an electronic teaching material. For example, an acquisition request for the electronic teaching material, multiplication table contains “http://xxx.xxx.xxx.1/2nd grade/class 1/20161209/arithmetic/multiplication table” as location information of the multiplication table. At OP2, the determiner 202 determines whether the electronic teaching material requested at OP1 is stored in the auxiliary storage 22b of the proxy server 13, referring to the management table 205. If the requested electronic teaching material is stored in the auxiliary storage 22b of the proxy server 13 (YES at OP2), the processing proceeds to OP5a. If the requested electronic teaching material is not stored in the auxiliary storage 22b of the proxy server 13 (NO at OP2), the processing proceeds to OP3. NO at OP2 is an exemplary situation that requested data is not stored in the storage.

At OP3, the acquirer 203 acquires, from the class server 12, the electronic teaching material in response to the request at OP1. At OP4, the acquirer 203 stores, in the auxiliary storage 22b, the electronic teaching material acquired at OP3.

At OP5, in response to the request at OP1, the transmitter 204 reads the electronic teaching material from the auxiliary storage 22b of the proxy server 13, and transmits the read electronic teaching material to the terminal 15 that has requested the acquisition at OP1. The operation at OP5a is the same as that at OP5, therefore, explanation thereof is omitted. The operations at OP5 and OP5a are an exemplary transmission of data from the acquirer to the requesting device.

At OP6, the acquirer 203 acquires, from the class server 12, electronic teaching materials stored in the same directory containing the electronic teaching material acquired at OP3. The acquirer 203 generates location information of the directory which stores the electronic teaching material, on the basis of the acquisition request received at OP1. If the electronic teaching material requested at OP1 is the multiplication table, the acquisition request contains “http://xxx.xxx.xxx.1/2nd grade/class 1/20161209/arithmetic/multiplication table” as the location information, as described above. The location information of the directory storing the multiplication table is generated by removing the file name, “multiplication table” from the location information of the electronic teaching material, multiplication table. The generated location information of the directory is, for example, “http://xxx.xxx.xxx.1/2nd grade/class 1/20161209/arithmetic/”. The acquirer 203 transmits, to the class server 12, a list request for a list of files including the generated location information of the directory. The acquirer 203 acquires, from the class server 12, a list of electronic teaching materials contained in the directory, as a response. The acquirer 203 acquires the electronic teaching materials from the class server 12 on the basis of the acquired list of electronic teaching materials. The operations at OP5 and OP6 are one example of acquiring, from the server, other data stored in a storage location in which the requested data is stored, after the transmission. The operations at OP3 and OP6 are one example of acquiring, from the server, other data stored in the same location of the storage, after transmitting the requested data.

At OP7, the acquirer 203 stores the electronic teaching materials acquired at OP6 in the auxiliary storage 22b of the proxy server 13. The operation at OP7 is one example of storing therein the data acquired from the server.

Processing Sequence by Lesson Support System 1

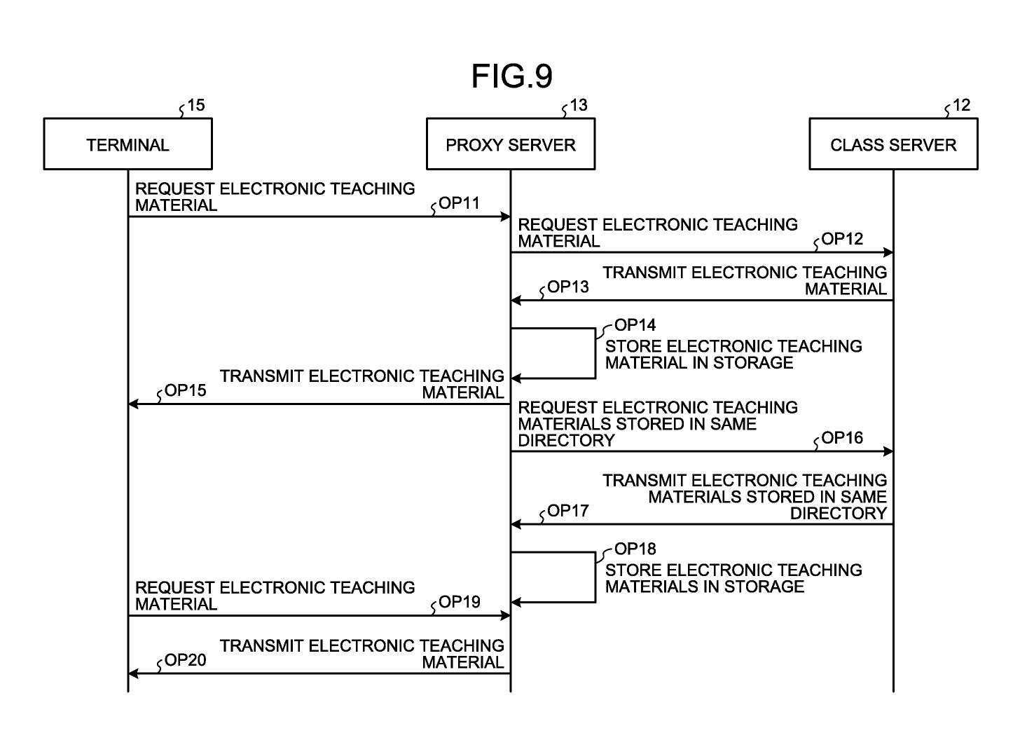

FIG. 9 is a sequence diagram of an exemplary processing sequence by the lesson support system 1 according to the first embodiment. FIG. 10 is a diagram of the exemplary processing sequence by the lesson support system 1 according to the first embodiment. FIG. 9 and FIG. 10 illustrate the exemplary processing sequence by the lesson support system 1 for an arithmetic lesson to the 2nd grade, class 1 on Dec. 9, 2016. One example of the processing by the lesson support system 1 will be described below with reference to FIG. 9 and FIG. 10.

At OP11 in FIG. 9, the terminal 15 transmits, to the class server 12, an acquisition request for the electronic teaching material, multiplication table. the acquisition request transmitted at OP11 is assumed to be the one transmitted from the terminal 15 for the first time after start of the lesson. The operation at OP11 corresponds to an operation at M1 in FIG. 10. At OP12 in FIG. 9, the proxy server 13 receives the acquisition request from the terminal 15 transmitted at OP11. The requested electronic teaching material, multiplication table at OP11 is not stored in the auxiliary storage 22b of the proxy server 13. Thus, the proxy server 13 transmits the acquisition request for the multiplication table to the class server 12. The operation at OP12 corresponds to an operation at M2 in FIG. 10.

At OP13 in FIG. 9, the class server 12 transmits the requested electronic teaching material, multiplication table to the proxy server 13. The operation at OP13 corresponds to an operation at M3 in FIG. 10. At OP14 in FIG. 9, the proxy server 13 receives the electronic teaching material, multiplication table from the class server 12 and stores it in the auxiliary storage 22b of the proxy server 13. The operation at OP14 corresponds to an operation at M4 in FIG. 10. At OP15 in FIG. 9, the proxy server 13 reads the electronic teaching material, multiplication table stored at OP14 from the auxiliary storage 22b. The proxy server 13 transmits the read multiplication table to the terminal 15. The operation at OP15 corresponds to an operation at M5 in FIG. 10.

At OP16 in FIG. 9, the proxy server 13 transmits, to the class server 12, an acquisition request for electronic teaching materials stored in the same directory containing the multiplication table requested by the terminal 15 at OP11, through the operation at OP6 in FIG. 8. The operation at OP16 corresponds to an operation at M6 in FIG. 10. At OP17 in FIG. 9, the class server 12 transmits, to the proxy server 13, the electronic teaching materials from the same directory storing the multiplication table. The operation at OP17 corresponds to an operation at M7 in FIG. 10. At OP18 in FIG. 9, the proxy server 13 receives the electronic teaching materials from the class server 12 and stores them in the auxiliary storage 22b of the proxy server 13. As described above with reference to FIG. 5, the class server 12 according to the first embodiment stores, in the same directory, the electronic teaching materials to be used in the same lesson. The operation at OP18 corresponds to an operation at M8 in FIG. 10.

At OP19 in FIG. 9, the terminal 15 transmits, to the class server 12, an acquisition request for an electronic teaching material, short test. The operation at OP19 corresponds to an operation at M9 in FIG. 10. At OP20 in FIG. 9, the proxy server 13 receives the acquisition request at OP19 from the terminal 15. Through the operation at OP18, the electronic teaching material, “short test”, which is stored in the same directory storing the electronic teaching material, multiplication table, is stored in the auxiliary storage 22b of the proxy server 13. The proxy server 13 reads, from the auxiliary storage 22b of the proxy server 13, the electronic teaching material, short test requested at OP19. The proxy server 13 transmits the read electronic teaching material, short test to the terminal 15. The operation at OP20 corresponds to an operation at M10 in FIG. 10.

The order of the operations illustrated in FIG. 9 and FIG. 10 may be changed. In FIG. 9, for example, the operation at OP15 may be performed after the operation at OP18.

First Example for Comparison

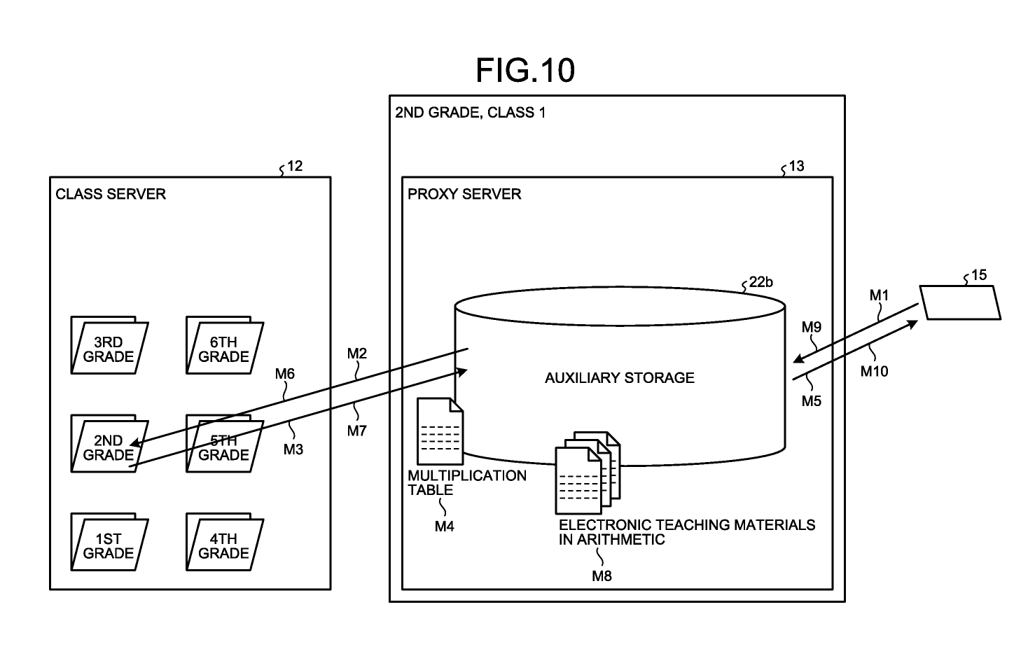

In the first embodiment, upon receiving an acquisition request for an electronic teaching material from the terminal 15, the proxy server 13 acquires the requested electronic teaching material from the class server 12 and stores the acquired material in the auxiliary storage 22b of the proxy server 13. Further, the proxy server 13 acquires electronic teaching materials stored in the same directory as the requested electronic teaching material from the class server 12, and stores the acquired materials in the auxiliary storage 22b of the proxy server 13. In a first example, the proxy server 13 acquires an electronic teaching material from the class server 12 and stores the acquired material in the auxiliary storage 22b of the proxy server 13 in response to an acquisition request from the terminal 15. However, the proxy server 13 according to the first example does not acquire, from the class server 12, other electronic teaching materials stored in the same directory as the requested electronic teaching material. FIG. 11 is a diagram illustrating an exemplary processing sequence according to the first example. The same operations as those in FIG. 10 are denoted by the same reference signs, and explanation thereof will be omitted. The processing sequence according to the first example will be described below with reference to FIG. 11.

In the first example, in response to the acquisition request from the terminal 15, the proxy server 13 acquires the electronic teaching material, multiplication table from the class server 12, and stores the acquired material in the auxiliary storage 22b through the same operations as at M1 to M4 in FIG. 10. The terminal 15 transmits the electronic teaching material, multiplication table from the auxiliary storage 22b to the terminal 15 through the same operation as M5 in FIG. 10.

Second Example for Comparison

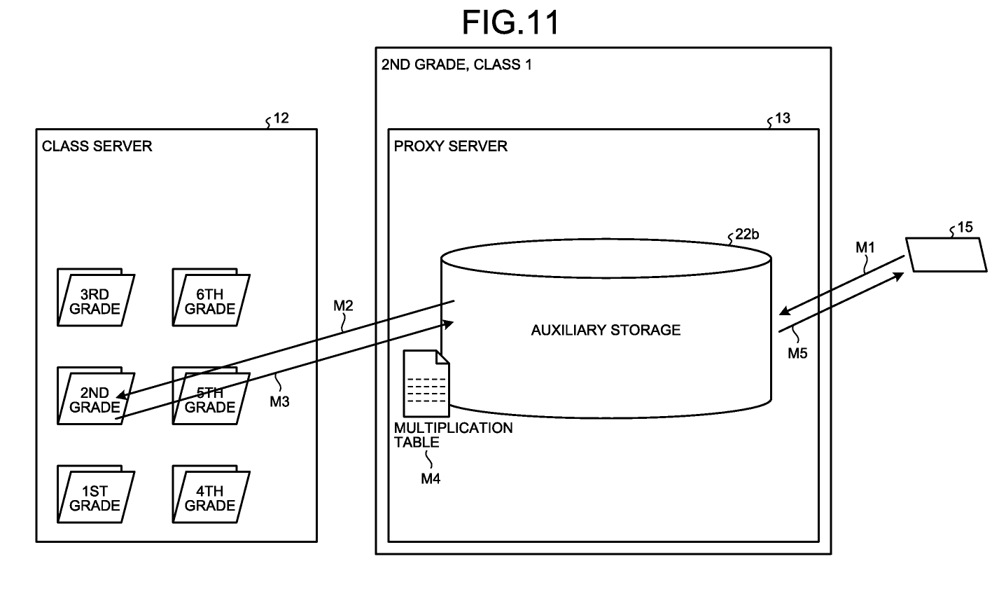

In the first embodiment, triggered by the acquisition request from the terminal 15, the proxy server 13 stores the requested electronic teaching material and the electronic teaching materials stored in the same directory in the auxiliary storage 22b of the proxy server 13. In a second example, a designated electronic teaching material is pre-stored in the auxiliary storage 22b of the proxy server 13 before the start of a lesson. FIG. 12 is a diagram of an exemplary processing sequence according to the second example. The same operations as those illustrated in FIG. 10 are denoted by the same reference signs, and explanation thereof will be omitted. The processing sequence according to the second example will be described below with reference to FIG. 12.

In the second example, operations at P1 to P3 are performed before a lesson starts. At P1, a teacher, for example, designates an intended electronic teaching material or directory in the proxy server 13. In this example, the designated directory is assumed to be arithmetic containing electronic teaching materials to be used for an arithmetic lesson to the 2nd grade, class 1 on Dec. 9, 2016. The proxy server 13 transmits an acquisition request for the designated arithmetic directory to the class server 12. At P2, the class server 12 transmits the requested arithmetic directory to the proxy server 13. At P3, the proxy server 13 receives the arithmetic directory from the class server 12 and stores it in the auxiliary storage 22b of the proxy server 13. Through the operations at M1 and M5, the terminal 15 acquires the electronic teaching materials from the proxy server 13.

Effects of First Embodiment

In the first example for comparison, the electronic teaching material requested by the terminal 15 is stored in the auxiliary storage 22b of the proxy server 13 through the operation at M4 in FIG. 11. That is, the terminals 15 can acquire electronic teaching materials from the proxy server 13 upon a request from any of the terminals 15. In the first example, however, electronic teaching materials are not stored in the auxiliary storage 22b of the proxy server 13 unless they are requested by the terminals 15. Thus, to acquire a non-requested electronic teaching material, the terminals 15 need to receive the electronic teaching material from the class server 12. This may elongate the length of time taken for the terminals 15 to acquire the electronic teaching material. In contrast, in the first embodiment, in response to a request for acquisition of an electronic teaching material from any of the terminals 15, the requested electronic teaching material and other electronic teaching materials stored in the same directory are transmitted together from the class server 12 and stored in the auxiliary storage 22b of the proxy server 13 through the operations at OP16 to OP18 in FIG. 9. Thus, the proxy server 13 according to the first embodiment can transmit, to the terminal 15, the electronic teaching materials stored in the same directory as the previously requested electronic teaching material, in place of the class server 12.

In the second example, an electronic teaching material designated before the start of a lesson is stored in the auxiliary storage 22b of the proxy server 13. Thus, the terminal 15 can acquire the electronic teaching material from the proxy server 13. However, the lesson does not necessarily progress as planned, so that designation of an electronic teaching material for storage in the proxy server 13 may be troublesome to teachers, for example. That is, teachers may start a lesson without designating an electronic teaching material for storage in the proxy server 13, to avoid such a trouble. Further, teachers may forget to designate an electronic teaching material for storage in the proxy server 13 before starting a lesson. Without the designation for storage, the electronic teaching material is not stored in the auxiliary storage 22b of the proxy server 13. Because of this, the terminal 15 needs to acquire the electronic teaching material from the class server 12. This may elongate the time taken for the terminal 15 to acquire the electronic teaching material.

In the first embodiment, triggered by the acquisition request from the terminal 15, the proxy server 13 stores the requested electronic teaching material and the electronic teaching materials stored in the same directory in the auxiliary storage 22b of the proxy server 13. According to the first embodiment, it is thus possible to omit the designation of electronic teaching materials for storage in the proxy server 13.

In the second example, the auxiliary storage 22b of the proxy server 13 stores the arithmetic directory containing the electronic teaching materials for use in the arithmetic lesson to the 2nd grade, class 1 on Dec. 9, 2016. However, if the lesson progresses further than planned, for example, the terminal 15 may transmit an acquisition request for an electronic teaching material for use on Dec. 10, 2016. In this case, the terminal 15 needs to acquire the electronic teaching material from the class server 12. This may elongate the time taken for the terminal 15 to acquire the electronic teaching material. Meanwhile, in the first embodiment, in response to an acquisition request for the electronic teaching material for use on Dec. 10, 2016 from any of the terminals 15, the requested electronic teaching material and other electronic teaching materials stored in the same directory are stored in the auxiliary storage 22b of the proxy server 13. That is, the terminals 15 can acquire the electronic teaching materials for use on Dec. 10, 2016 from the auxiliary storage 22b of the proxy server 13. Consequently, according to the first embodiment, it is possible to prevent increase in the time taken to acquire the electronic teaching materials, as compared with the second example.

In the second example, in the case of a change in the grade or class in which the proxy server 13 is used or replacement of the proxy server 13 due to a failure, for example, electronic teaching materials to store in the auxiliary storage 22b of the proxy server 13 need to be re-designated. However, in the first embodiment, triggered by the acquisition request from the terminal 15, electronic teaching materials are stored in the auxiliary storage 22b of the proxy server 13. This makes it possible to omit the designation of electronic teaching materials for storage in the auxiliary storage 22b of the proxy server 13 even if there is a change in the grade or class using the proxy server 13, or the proxy server 13 having a failure has been replaced.

In the first embodiment, the electronic teaching materials are classified for each lesson in which the materials are used, and stored in each directory, as described with reference to FIG. 5. That is, The directory of the requested electronic teaching material contains the other electronic teaching materials for use in the same lesson. Thus, the auxiliary storage 22b of the proxy server 13 stores the electronic teaching materials to be used in the same lesson. In other words, according to the first embodiment, the proxy server 13 can perform storing of electronic teaching materials for use in a lesson in the auxiliary storage 22b, triggered by an acquisition request for an electronic teaching material from the terminal 15. Thus, after any of the terminals 15 requests acquisition of an electronic teaching material for use in a lesson, all the terminals 15 can acquire the electronic teaching materials from the proxy server 13 during the lesson.

In the first embodiment, the proxy server 13 acquires the requested electronic teaching material from the class server 12 (OP3 in FIG. 8), and transmits the acquired electronic teaching material to the terminal 15 (OP5 in FIG. 8). The proxy server 13 then acquires the electronic teaching materials stored in the same directory as the requested electronic teaching material from the class server 12, and stores the acquired materials in the auxiliary storage 22b of the proxy server 13 (OP6 and OP7 in FIG. 8). Through the above operations, the proxy server 13 can transmit the requested electronic teaching material to the terminal 15 in a shorter response time than through the operation at OP5 after operations at OP6 and OP7 in FIG. 8.

In the first embodiment, the directory containing the electronic teaching material, multiplication table requested by the terminal 15 includes no other directories. However, the directory containing the electronic teaching material, multiplication table requested by the terminal 15 may contain another directory. The directory inside the directory of the multiplication table is considered to contain electronic teaching materials for the same lesson as the requested electronic teaching material. In view of this, the proxy server 13 acquires the electronic teaching materials and directories from the same directory containing the requested electronic teaching material. The proxy server 13 only needs to store the acquired electronic teaching materials and directories in the auxiliary storage 22b. The directories acquired by the proxy server 13 are one example of data.

In the first embodiment, the proxy server 13 acquires electronic teaching materials from the same directory containing the requested electronic teaching material at OP16 and OP17 in FIG. 9. As a modification of the operations at OP16 and OP17 in FIG. 9, for example, the proxy server 13 may acquire the directory containing the requested electronic teaching material.

In the first embodiment, the electronic teaching materials are stored in the directories, but storage locations of the electronic teaching materials are not limited to the directories. In the case of using Windows (registered trademark) as the OS of the class server 12, for example, data or the electronic teaching materials may be stored in a storage different from the directories, such as C drive or D drive. The storage different from the directories, such as C drive or D drive, is one example of storage location.

In the class server 12 according to the first embodiment, the electronic teaching materials are classified for each lesson in which the materials are used, and stored in each directory. However, the classification and storing method for electronic teaching materials is not limited to the one for classifying the materials for each lesson. The electronic teaching materials may be classified for each unit of subjects and stored in each directory, for example.

In the first embodiment, the proxy server 13 stores and transmits the electronic teaching materials. However, the objects to be stored and transmitted by the proxy server 13 are not limited to the electronic teaching materials. Examples of the objects to be stored and transmitted by the proxy server 13 may include materials for use in seminars, study groups, or conferences, various kinds of data for use in information sharing in a company, or data as contents to be distributed through contents distribution. Such various items of data are typically classified into groups by relevance and stored in directories. If the proxy server 13 according to the first embodiment is applied to a system that utilizes such data, the requested data and other data stored in the same directory are stored in the auxiliary storage 22b of the proxy server 13. Relevant data is typically stored in the same directory as described above, therefore, the proxy server 13 can store the requested data and relevant data together in the auxiliary storage 22b of the proxy server 13.

First Modification

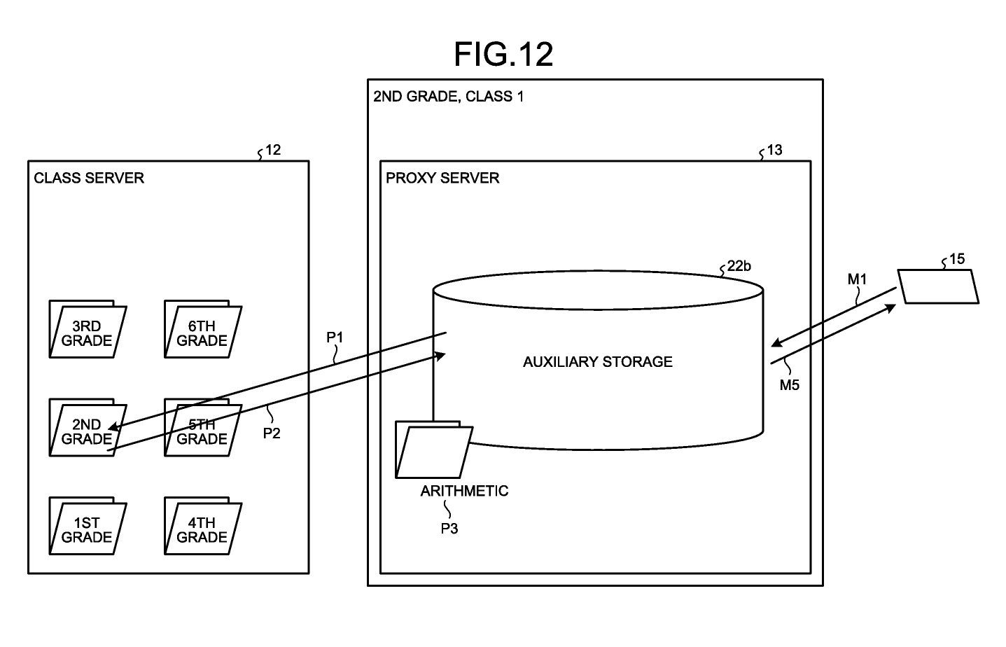

The first embodiment has described the example of classifying the electronic teaching materials for each lesson in which the materials are used and storing them in each directory. That is, in the first embodiment, a determination is made on whether the electronic teaching materials are to be used in the same lesson depending on whether the materials are stored in the same directory. However, the directory configuration of the class server 12 is not limited to such an example. FIG. 13 is a diagram illustrating an exemplary directory configuration of the class server 12 that stores electronic teaching materials according to a first modification. The class server 12 according to the first modification stores electronic teaching materials to be used in different lessons in the same directory. For example, a subordinate directory, class 1 of the 2nd-grade directory contains electronic teaching materials to be used in lessons of the 2nd grade, class 1. With reference to FIG. 13, for example, the subordinate directory of the 2^{nd}-grade directory contains electronic teaching materials, such as “20161208social science_timeline”, “20161209arithmetic_short test”, “20161209arithmetic_multiplication table”, and “20161209science_magnet”. The subordinate directory of the 2^{nd}-grade directory also contains a directory “20161209arithmetic_graph”.

With reference to FIG. 13, the file names of the electronic teaching materials and the name of the directory for use in the same lesson are given a common header. In the following, the file names and the directory name will be collectively referred to as names. The header includes, for example, information on dates and subjects. In other words, the names of the electronic teaching materials and the directory include headers that represent a common intended usage. For example, the header of the electronic teaching materials for use in the arithmetic lesson on Dec. 9, 2016 is “20161209_0201_arithmetic_”. For example, the electronic teaching material “20161209_0201_arithmetic_multiplication table” in FIG. 13 is used in the arithmetic lesson to the 2nd grade, class 1 on Dec. 9, 2016. Upon receiving an acquisition request for the electronic teaching material with the name “20161209_0201_arithmetic_multiplication table” from the terminal 15, the proxy server 13 acquires the electronic teaching material concerned from the class server 12. Further, the proxy server 13 acquires, from the directory of the class server 12 containing the requested electronic teaching material, the electronic teaching materials and the directory with the names including the same header “20161209_0201 arithmetic_” as that of the requested electronic teaching material. The proxy server 13 only needs to store the acquired electronic teaching materials and directory in the auxiliary storage 22b. The method of distinguishing the header from the rest of the name is not specifically limited. The header may be separated from the rest of the name by a predetermined delimiter, and the top of the name to the delimiter may be determined as the header. Alternatively, the number of characters of the header is pre-defined to determine the defined number of characters from the top of the name as the header. According to the first modification, it is made possible to specify and acquire electronic teaching materials for use in the same lesson in which the requested electronic teaching material is used, from the directory of the class server 12 that stores electronic teaching materials and directories to be used in different lessons.

### Second Embodiment

In the lesson support system 1 according to the first embodiment, in response to an acquisition request for an electronic teaching material from the terminal 15, the proxy server 13 acquires, from the class server 12, the requested electronic teaching material and other electronic teaching materials stored in the same directory. In the lesson support system 1 according to a second embodiment, upon receiving an acquisition request for an electronic teaching material from the proxy server 13, the class server 12 transmits the requested electronic teaching material and other electronic teaching materials stored in the same directory to the proxy server 13. The second embodiment is the same as the first embodiment except that the class server 12 transmits the electronic teaching materials from the same directory storing the requested electronic teaching material to the proxy server 13. Thus, the following will mainly describe differences from the first embodiment. The second embodiment will be described below with reference to the drawings.

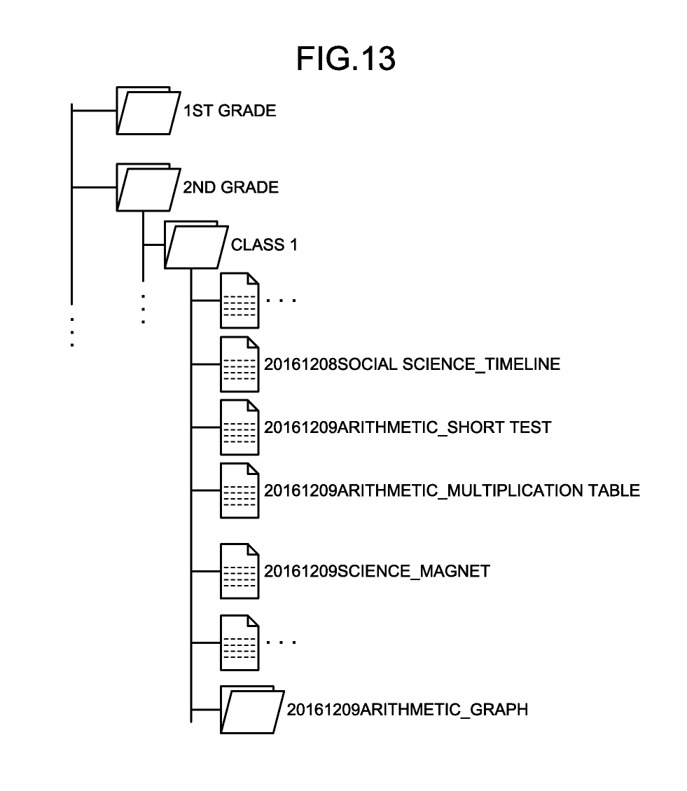

FIG. 14 is a diagram illustrating an example of processing blocks of the class server 12 according to the second embodiment. The class server 12 includes a receiver 301 and a transmitter 302. In the class server 12 the controller 21 loads a computer program on the main storage 22a and executes the computer program to implement the operations of the receiver 301 and the transmitter 302 of the class server 12. One example of the processing blocks of the class server 12 will be described below with reference to FIG. 14.

The receiver 301 receives an acquisition request for an electronic teaching material from the proxy server 13. The transmitter 302 transmits the requested electronic teaching material to the proxy server 13. The transmitter 302 also transmits electronic teaching materials stored in the same directory containing the requested electronic teaching material to the proxy server 13.

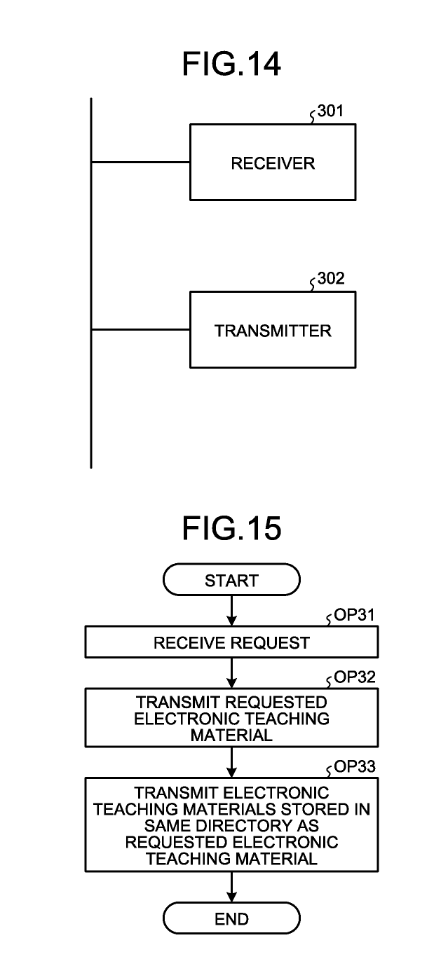

FIG. 15 is a flowchart illustrating an exemplary processing by the class server 12 according to the second embodiment. An exemplary processing by the class server 12 according to the second embodiment will be described with reference to FIG. 15.

At OP31, the receiver 301 receives an acquisition request for an electronic teaching material from the proxy server 13. At OP32, the transmitter 302 transmits the requested electronic teaching material at OP31 to the proxy server 13. At OP33, the transmitter 302 generates location information of a directory in which the electronic teaching material requested at OP31 is stored, through the same operation as that at OP6 described in FIG. 9. The transmitter 302 transmits, to the proxy server 13, the electronic teaching materials from the same directory storing the electronic teaching material requested at OP31, on the basis of the generated information. The operations at OP32 and OP33 are one example of reading, from the storage, requested data and other data stored in the same location of the storage, and transmitting the read data to the proxy device.

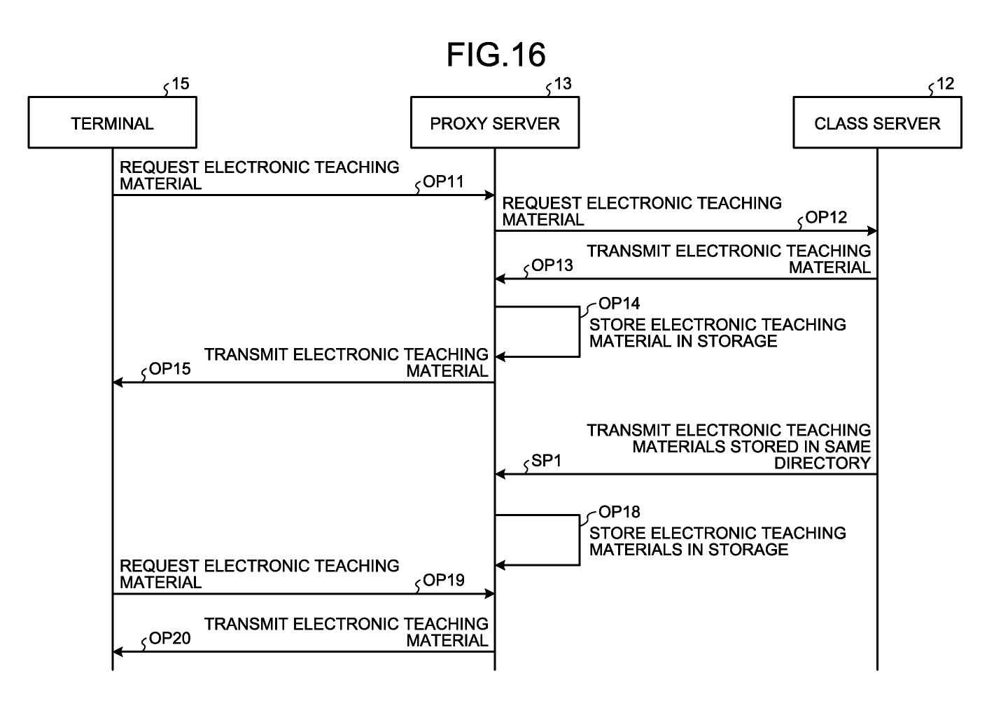

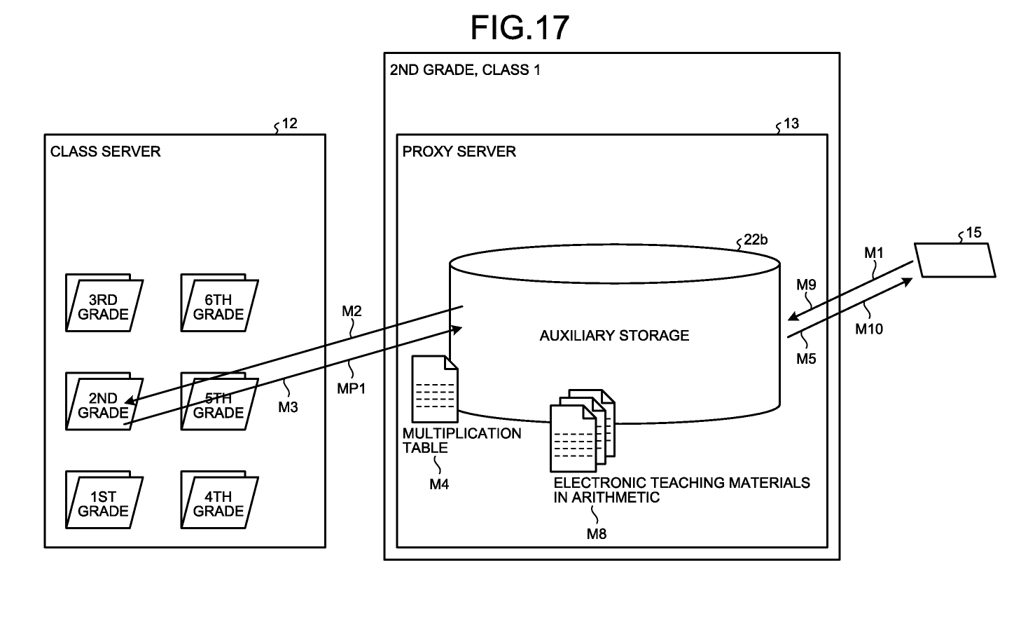

FIG. 16 is a sequence diagram illustrating an example of the processing sequence by the lesson support system 1 according to the second embodiment. FIG. 17 is a diagram illustrating the example of the processing sequence by the lesson support system 1 according to the second embodiment. FIG. 16 and FIG. 17 illustrate an example of the flow of operations by the lesson support system 1 for the arithmetic lesson to the 2nd grade, class 1 on Dec. 9, 2016, as with FIG. 9 and FIG. 10. In FIG. 16 and FIG. 17, the same operations as those illustrated in FIG. 9 and FIG. 10 are denoted by the same reference signs, and explanation thereof will be omitted. One example of the processing sequence by the lesson support system 1 according to the second embodiment will be described below with reference to FIG. 16 and FIG. 17.

Operations at OP11 to OP15 in FIG. 16 are the same as the operations at OP11 to OP15 in FIG. 9, and operations at M1 to M5 in FIG. 17 are the same as the operations at M1 to M5 in FIG. 10, so that explanation thereof will be omitted. At SP1 in FIG. 16, the class server 12 transmits, to the proxy server 13, the electronic teaching materials from the same directory containing the requested electronic teaching material, multiplication table at OP12, through the operation at OP33 in FIG. 15. The operation at SP1 corresponds to an operation at MP1 in FIG. 17. Operations at OP18 to OP20 in FIG. 16 are the same as the operations at OP18 to OP20 in FIG. 9, and operations at M8 to M10 in FIG. 17 are the same as the operations at M8 to M10 in FIG. 10, therefore, explanation thereof will be omitted.

The order of the operations illustrated in FIG. 16 and FIG. 17 may be changed. For example, the operation at OP15 may be performed after the operation at OP18 in FIG. 16.

In the second embodiment, when receiving a request for an electronic teaching material from the proxy server 13, the class server 12 transmits the requested electronic teaching material and electronic teaching materials stored in the same directory to the proxy server 13. This eliminates the necessity for the proxy server 13 to request acquisition of the other electronic teaching materials stored in the same directory containing the requested electronic teaching material.

The embodiments and the modifications disclosed above may be combined appropriately. For example, the second embodiment and the first modification may be combined. In this combination, the class server 12 only needs to transmit, to the proxy server 13, an electronic teaching material with a file name including the same header as the header of the file name of the requested electronic teaching material, for example.

The proxy device according to any of the embodiments and the modifications enables omission of designation of data to be stored in the proxy device that transmits data to a requesting device in place of a server.

Computer-readable Recording Medium

An information processing program that causes a machine or a device such as a computer (hereinafter, referred to as a computer) to implement any of the above-described functions may be recorded on a computer-readable recording medium. The computer is caused to read and execute the program on the recording medium, to thereby provide the functions.

Herein, the computer-readable recording medium refers to a recording medium that can store information such as data and programs electrically, magnetically, optically, mechanically, or chemically and allows the computer to read the information. Examples of detachable medium from the computer among such recording media include, a flexible disk, a magneto optical disk, a computer disc read only memory (CD-ROM), a compact disc-recordable (CD-R), a compact disc-rewritable (CD-RW), a digital versatile disk (DVD), a Blu-ray disk (BD), a digital audio tape (DAT), an 8-mm tape, and a memory card including a flash memory. Examples of the recording medium fixed to the computer include a hard disk and a ROM.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

What is claimed is:

1. A proxy device comprising:
a request receiver that receives a request for acquisition of data from a requesting device;
an acquirer that acquires the requested data from a server;
storage that stores therein the data acquired from the server; and
a controller that controls, upon no storage of the requested data in the storage, the acquirer to acquire, from the server, the requested data and other data stored in a same location of the storage.

2. The proxy device according to claim 1, wherein
the controller further transmits the requested data acquired by the acquirer to the requesting device, and
the acquirer acquires, from the server, other data stored in the same location of the storage as the requested data, after transmitting the requested data.

3. The proxy device according to claim 1, wherein
the data has a name containing a header, and
the acquirer acquires the other data with a name containing the header of the name of the requested data.

4. The proxy device according to claim 1, wherein
the other data stored in the same location of the storage comprises a first file and a second file, the first file being stored in a same directory containing the requested data, the second file being stored in a subordinate directory of the same directory.

5. The proxy device according to claim 4, wherein
the other data stored in the same location of the storage comprises the subordinate directory.

6. A provider device comprising:
storage that stores data; and
a transmitter that, in response to a request for acquisition of data from a requesting device via a proxy device, reads, from the storage, requested data and other data stored in a same location of the storage, and transmits the read data to the proxy device.

7. The provider device according to claim 6, wherein
the data comprises an electronic teaching material to be used in a lesson, and
the storage stores the electronic teaching material to be used in the lesson having at least one of a subject, a grade, a course unit, and a lesson date of the lesson in which the requested data.

8. The provider device according to claim 6, wherein
the data has a name containing a header, and
the transmitter transmits the other data with a name containing the header of the name of the requested data.
